(19) United States
(12) Patent Application Publication
(10) Pub. No.: US 2009/0089991 A1
(43) Pub. Date: Apr. 9, 2009

(54) VALVE SPRING COMPRESSOR

(75) Inventors: Vladimir Saprykin, Renton, WA (US); Danny L. Williams, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/868,560

(22) Filed: Oct. 8, 2007

(51) Int. Cl. B25B 27/26

(52) U.S. Cl. 29/218

(57) ABSTRACT

A tool for compression of a spring comprises a yoke, a longitudinal bore defining an axis and three radial slots extending from the axis of the bore. Arms associated with an alignment pin are pivotal and engage hooked legs of the tool slidably mounted in two opposed radial slots to adjust the lateral spacing thereof. A drive rod positioned between the legs includes an anvil that may be driven to compress a coil spring engaged between the legs and the anvil.

### BACKGROUND OF THE INVENTION

The present invention relates to an automotive tool and, more particularly, to an automotive tool useful for the compression of coil springs, especially valve springs associated with an internal combustion engine. However, the spring compression tool may be utilized to compress coil springs associated with various types of mechanisms and thus its use is not limited to compression of a valve spring for a motor vehicle engine.

Repair of motor vehicle engines, particularly those having an overhead valve construction, typically requires compressing the overhead valve spring to thereby enable removal of a valve lock in the spring retainer which maintains the spring in compression. Various valve spring compression tools are available in the market or have been proposed. For example, Lisle Corporation offers a valve spring compressor, Model 16750, which includes a pair of depending legs designed to grip spiral turns of a coil spring in combination with an anvil which may be driven against the spring retainer to enable compression of the spring and removal of the valve lock. Various types of compression tools are available from Lisle Corporation, including Model 44300, valve spring compressor; Model 23300, small engine valve spring compressor; and Model 36200, valve keeper, remover and installer. In addition, other commercially available valve spring compression tools are available from suppliers, including the Imperial valve spring compressor by Stride Tool Inc.; Plews valve spring compressors including Model 72-215, overhead valve spring compressor; Sears Craftsman overhead valve spring compressor, Sears item no. 00947704000, manufacturer Model No. 47704; Snap-On valve spring compressors including Models YA9140; YA3271; Model VST 100 and Model CG90; Auto Zone valve spring compressor Model No. OEM27040; KD valve spring lifter and compressor Model No. KD2078 and Model No. 3271.76; and SJ Discount Tools including KD Tool Model 3271.

Most of these tools operate in essentially the same manner as the Lisle tool described above. That is, a pair of legs are provided for gripping the coils of the valve spring and an anvil is provided for engaging or compressing against the spring retainer. A mechanism is provided to move or drive the anvil and thereby compress the valve spring enabling removal of the valve lock.

While such tools have proven to be useful and well accepted in the marketplace, various technical concerns relating to their use have developed. That is, the legs associated with the tools typically are not capable of significant adjustment to accommodate the coil helix or the width of the spring being compressed. Those that are adjustable require a design which may be considered too bulky and not capable of fitting into restricted passages. Thus there has developed the need for a valve spring compressor which permits access of the tool in restricted access areas. These features, among others, are considered desirable in a spring compression tool.

### SUMMARY OF THE INVENTION

Briefly the present invention comprises a tool for compression of a spring. The tool includes a yoke with a medial throughbore having a longitudinal axis. First, second and third radial slots extend outwardly from the longitudinal axis of the yoke. The first and third slots are generally in linear alignment transverse to the longitudinal axis. A first spring engaging leg is slidably mounted in the first slot. A second spring engaging leg is slidably mounted in the third slot. The legs extend generally parallel to the longitudinal axis and are slidably moveable toward and away from the longitudinal axis in their respective slots.

A threaded drive rod is mounted for axial movement in the throughbore. The threaded drive rod is connected to an anvil positioned between the first and second legs. Thus, the threaded drive rod may be rotated which results in it moving axially to thereby engage the anvil and impart axial movement thereto. First and second guide arms are attached respectively at their inner end to the first and second legs respectively. Each leg is also independently adjustable in the axial direction. The guide arms are connected at their outer end to one another by a fastener to enable pivotal movement with respect to one another. A centering pin is connected to at least one of the guide arms. The guide pin is slidably positioned in the second radial slot intermediate the first and third radial slots. As the centering pin is moved radially in the second slot, it causes the guide arms to pivot with respect to one another and thereby cause their inner ends to move the first and second legs outwardly or inwardly in the first and third slots respectively. The movement of the legs is proportional due to the movement of the guide arms.

The longitudinal movement of the drive rod is typically effected by threadable engagement of the drive rod with the threaded yoke throughbore. A handle or other drive member may be attached to the drive rod to effect its longitudinal movement.

The outer end of the first and second guide arms includes a centering pin which slidably moves in the second slot and thereby effects inward and outward movement of the first and second spring engaging legs.

The anvil includes a radial arm with a projecting pin that extends axially and fits through the second slot to ensure that the anvil is maintained in a nonrotatable position as it moves upwardly and downwardly in a longitudinal direction.

In use, the first and second legs are appropriately adjusted in length to compensate for the helix of the spring coils and hooked ends thereof are engaged with a coil of a coil or spiral spring. The anvil, which is situated between the legs, is then positioned against a spring retainer plate. The drive rod then is rotated to move the anvil and compress the spring so that the valve lock (sometimes termed a keeper) for the spring may be removed thereby enabling disengagement of the spring from the stem of a valve associated with the valve spring. The spacing of the legs is adjusted by inward and outward movement thereof proportionally on opposite sides of the longitudinal axis by virtue of the guide arms connected at their inner end to the legs and at their outer end to the pin slidably in the radial second slot.

Thus it is an object of the invention to provide and improve valve spring compression tool.

Another object of the invention is to provide an improved valve spring compression tool which enables lateral adjustment of legs to accommodate a range of diameters of valve springs.

Another object of the invention is to provide a valve spring compression tool which is compact and which is designed to fit in restricted access spaces.

A further object of the invention is to provide a valve spring compression tool which is rugged, inexpensive, easily adjusted and which provides valve spring engaging legs which are designed to engage the valve spring generally parallel to a longitudinal centerline axis of the valve spring.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of an embodiment of a spring compression tool of the invention positioned for engagement with a valve spring and illustrating the manner of use of the tool;

FIG. 2 is an isometric view of the tool of FIG. 1 depicting the component parts thereof;

FIG. 3 is an exploded isometric view of the tool of FIGS. 1 and 2;

FIG. 4 is a front elevation of the tool of FIG. 2;

FIG. 5 is a cross-sectional view of the tool of FIG. 4 taken along the line 5-5;

FIG. 6 is a top plan view of the tool of FIG. 4; and

FIG. 7 is an isometric view of a typical prior art valve compression tool.

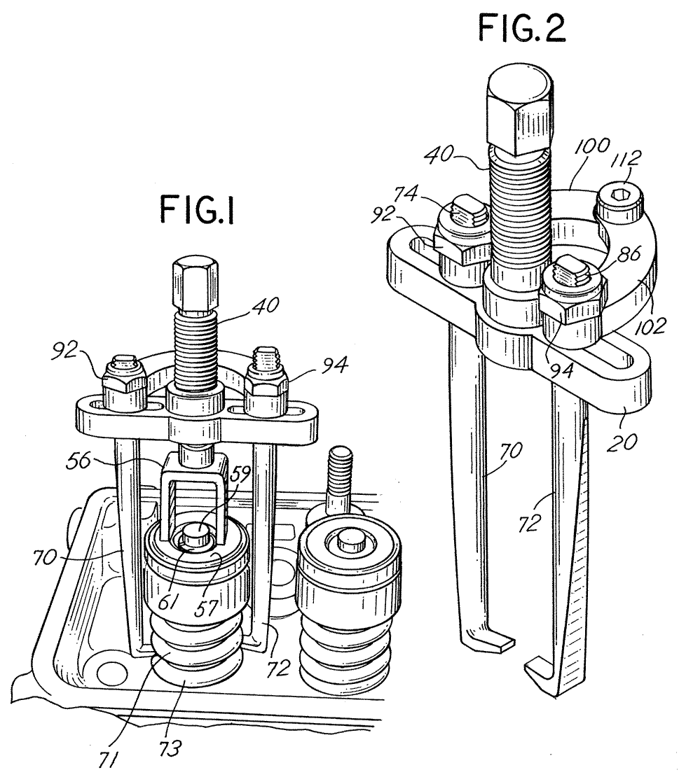

### DESCRIPTION OF AN EMBODIMENT OF THE INVENTION

An embodiment of a spring compression tool of the invention includes a yoke 20 which is in the form of a machined metal plate having a first radial slot 22, a second radial slot 24 and a third radial slot 26 extending generally transversely from a longitudinal, center axis 28 of a threaded throughbore 30 at the center of the yoke 20. The slots 22, 24 and 26 are thus radial slots and extend from adjacent a cylindrical central section 32 of the yoke 20 radially outward. The slots 22, 24 and 26 are at generally 90 degree angles from one another. Thus the first slot 22 and the third slot 26 all are typically in linear alignment. The second slot 24 forms a right angle with respect to the first slot 22 and third slot 26. The slots 22, 24, 26 are of equal length in the radial direction, but may be unique lengths.

A threaded drive rod 40 is in axial alignment with the axis 28 and is threaded through the bore 30. The threaded drive rod 40 includes a polygonal head 42 which is cooperative with a socket 44 of a manual drive handle 46. Placement of the drive handle 46 on the polygonal head 42 enables rotational movement of the drive rod 40 and provides a mechanical advantage to effect appropriate rotational movement of the drive rod 40.

The bottom end 41 of the drive rod 40 opposite the polygonal head 42 includes a retainer pin 50 that has a knurled end 96 which fits within a bore 52 in a cylindrical passage or ring 54 of an anvil 56. Anvil 56 includes spaced, generally parallel, flat planar anvil legs 58 and 60. The pin 50 and bore 52 are co-axial with the axis 28. A retaining ring 51 is provided to retain the pin 50 within a counterbore 53 in the lower end 41 of the drive rod 40. The drive rod 40 is thus threaded through the bore 30 and connected to the anvil 56 by means of the pin 50 and the retaining ring 51. The anvil legs 58 and 60 are spaced from one another and are positioned radially outwardly from the longitudinal axis 28 so that the distal ends of legs 58, 60 are capable of engagement with a cap retainer 57 for a valve spring such as depicted in FIG. 1.

The anvil 56 further includes a radially extending support bracket or arm 64. The support bracket or arm 64 includes a bore 65 which receives the knurled end 67 of an alignment rod or pin 69 that extends longitudinally parallel to the axis 28 and upwardly from the arm 64. The alignment rod or pin 69 is of an adequate length to extend upwardly through the radial slot 24 of the yoke 20. The alignment rod or pin 69 extends through the radial slot 24 as the anvil 56 is driven upwardly and downwardly in the longitudinal axial direction 28. The alignment rod or pin 69 thus maintains the anvil 56 oriented properly between the spaced legs 70 and 72.

The yoke 20 and more particularly the first slot 22 and the third slot 26 are typically of equal radial dimension and receive a first leg 70 and a second leg 72 respectively. The first leg 70 includes a threaded top section 74 with opposite side flats 76 and 78 which fit against the flat interior surfaces 80 and 82 respectively of the slot 22. In this manner the orientation of the leg 70 is maintained as it will not rotate. The leg 70 further includes a lower hook element 84 which extends toward the second leg 72. The construction of the first leg 70 and the second leg 72 is substantially identical. Thus the second leg 72 includes upper section 86 with flats that cooperate with the third flat sided, radial slot 26. An inwardly extending hook 88 is in opposed relation to the hook end 84 of leg 70. The legs 70 and 72 thus are slidable radially in the respective slots 22 and 26. The legs 70 and 72 respectively cooperate with threaded fasteners 92 and 94 which adjust the relative longitudinal position of the legs 70 and 72 in the slots 22 and 26 of the yoke 20.

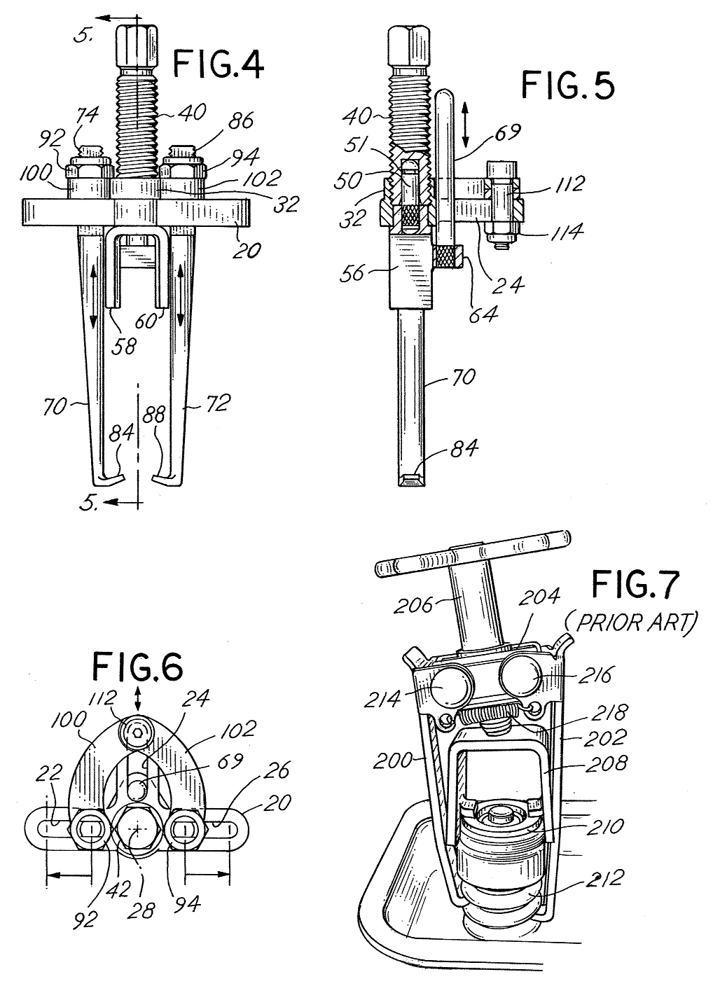

A first arm 100 and a second arcuate arm 102 are fitted over the top end such as end 74 of the leg 70 and the upper section 86 of leg 72. More specifically the arm 100 includes a passage 104 which receives the top end 74 of the leg 70. Similarly, the end of the second arm 102 receives upper section 86 of the second leg 72 through a passage 106. The opposite end of each of the arms 100 and 102 includes a passage or opening, 108 and 110 respectively, which receives a centering pin 112 that is retained by a fastener 114. The first and second arms 100 and 102 thus may pivot about the centering pin 112. As shown in FIG. 5, the pin 112 fits through slot 24 in the yoke 20. The opposite ends of the arms 100 and 102 are rotatably connected to the legs 70 and 72 respectively. The centering pin 112 thus is slidable in the second radial slot 24 inwardly and outwardly. Upon sliding inwardly toward the longitudinal axis 28, the legs 70 and 72 are made to slide outwardly in the radial slots 22 and 26 respectively. Reverse movement of the centering pin 112 effectively moves the legs 70 and 72 inwardly toward one another in the radial slots 22 and 26 respectively.

Since the centering pin 112 fits through the second slot 24 and the fastener 114 fits against the underside of the yoke 20 adjacent to the radial slot 24, the arms 100 and 102 are maintained fixed in an axial position against the yoke 20. Thus the arms 100 and 102 will hold the legs 70 and 72 in position. The legs 70 and 72 may be adjusted upwardly and downwardly, of course, in their respective slots and in the arms.

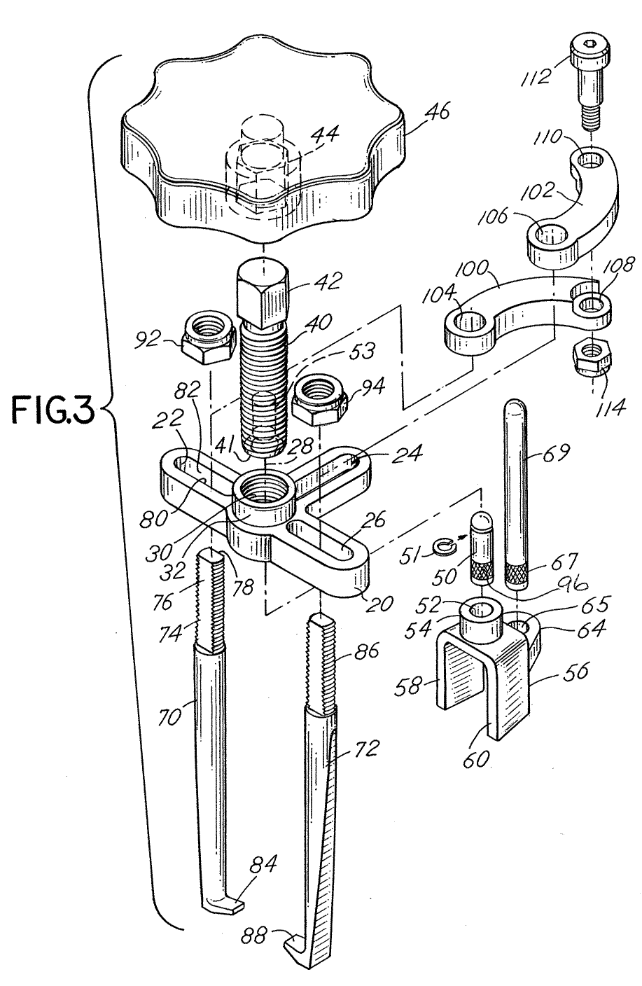

As previously described, the anvil 56 includes support bracket 64 which receives an alignment rod or pin 69 that extends longitudinally in the axial direction through the bore 65 and parallel axis 28 and projects through the second slot 24 as depicted in FIG. 3 to retain the anvil 56 in alignment and nonrotatable with respect to the longitudinal axis 28. Thus as the anvil 56 is moved upwardly and downwardly by rotation of the rod 40, the vertical pin 69 in FIG. 3 will retain the anvil 56 oriented in the manner depicted in FIGS. 4 and 5.

In use the tool is positioned as depicted in FIG. 1 wherein the first leg 70 is engaged with a coil 71 of a spring 73. The second leg 72 is engaged with a coil 71 on the opposite side thereof. The fasteners 92 and 94 permit adjustment of the relative longitudinal extension of the legs 70 and 72. The anvil 56 is then brought to bear against the spring retainer element 57 so that the valve stem 59 and more particularly the valve lock 61 which holds the compression or valve spring in position on the valve stem 59 can be released. That is the anvil 56 in combination with the first leg and second leg 70 and 72 will compress the spring 73 thereby releasing the spring cap or cover 57 so as to enable removal of the valve lock 61 and thus disengagement of the valve stem 59 from the compression spring 73. The drive rod 40 is manually driven by virtue of the drive handle 46 or alternatively by means of a wrench or power tool which engages against the polygonal head 42 to thereby move the anvil 56 and compress the spring 73.

With the tool of the embodiment it is possible to adjust the lateral spacing of the legs 70 and 72 as well as the longitudinal position of the legs 70 and 72. The anvil 56 may be moved upwardly and downwardly by actuation of the drive rod 40. As depicted in FIG. 6 the arms 100 and 102 may be adjusted to control the spacing of the legs 70 and 72. FIG. 6 therefore illustrates the travel of the legs 70 and 72 as viewed from the top plan view. The travel of the legs 70 and 72 is proportional to the travel or movement of the arms 100 and 102 inwardly and outwardly toward the center line axis 28.

FIG. 7 for purposes of contrast illustrates a typical prior art spring compression tool. In such a device a first leg 200 and a second leg 202 are pivotally mounted on a yoke 204 which includes a drive rod 206 that engages an anvil 208 designed to fit on and engage a spring retainer 210 of a coil spring 212. The coil spring 212 has coils that are engaged by inwardly pivoting hook elements of the legs 200 and 202. It should be noted that the yoke 204 has legs 200 and 202 attached thereto by pivot connections 214 and 216. The pivoting of the legs 200 and 202 about the pivot connections 214 and 216 is augmented by a spring member 218 which pulls the legs 200 and 202 toward one another. The prior art construction does not include legs that are adjustable proportionately in terms of their spacing while maintaining the generally parallel relationship of those legs in alignment with the axis of the drive rod. As such the prior art construction is typically more bulky and sometimes difficult to use in limited access locations.

While there has been set forth a preferred embodiment of the invention, it is to be understood that the invention is to be limited only by the following claims and equivalents thereof. Various modifications may be made, for example, including alternative configurations for the arms 100 and 102, alternative configurations for the anvil 56, alternative shapes and configurations for the legs 70 and 72 and a different configuration for the yoke 20. The position and alignment of the slots for the yoke 20 may be varied. The means of connecting the arms to the yoke may be varied. Thus far there has been disclosed an embodiment of the invention; however, the invention is to be limited only by the following claims and equivalents thereof.

What is claimed is:

1. A tool for compression of a spring comprising, in combination:
a yoke including a medial throughbore defining a longitudinal axis, said yoke further including first, second and third radial slots extending outwardly from the axis, said first and third slots generally in linear alignment transverse to the axis;
a first spring engaging leg slidably mounted in the first slot;
a second spring engaging leg slidably mounted in the third slot;
a drive rod mounted for axial movement in the throughbore;
an anvil positioned between the first and second legs and connected to the drive rod for axial movement in response to axial movement of the drive rod;
a first guide arm having one end attached to the first leg;
a second guide arm having one end attached to the second leg; said first and second arms each having a second end rotationally joined together; and
a centering pin connected to at least one of said arms, said centering pin slidably positioned in the second slot, said second slot intermediate the first and third slots, said centering pin generally parallel to the axis whereby the movement of the centering pin in the second slot imparts proportional movement of the first and second legs in the first and third slots to thereby adjust the spacing of the legs.

2. The tool of claim 1 wherein the drive rod is threaded through the yoke.

3. The tool of claim 2 wherein the anvil comprises a U shaped member having spaced runs.

4. The tool of claim 2 wherein the anvil further includes an alignment member engaging the yoke to prevent rotational movement of the anvil.

5. The tool of claim 4 wherein the alignment member comprises an elongate pin generally parallel to the axis and projecting into the third slot.

6. The tool of claim 1 wherein the legs each include a hooked end for engaging a coil spring.

7. The tool of claim 1 wherein the first and second legs are non-rotatably keyed in the respective slots.

8. The tool of claim 1 wherein the first and second legs are longitudinally adjustably mounted to the respective arms.

9. The tool of claim 1 wherein the centering pin is slidably mounted to the yoke.

10. The tool of claim 1 further including a drive member attached to the drive rod for rotationally moving the drive rod.

11. The tool of claim 1 wherein the arms define equal length pivot arms.

12. The tool of claim 1 wherein the radial slots are equally spaced.

13. The tool of claim 12 wherein the radial slots are spaced about 90 degrees from each other.

14. The tool of claim 11 wherein the guide pin is rotatably attached to both arms and slidably mounted in the second slot.

15. The tool of claim 14 wherein the guide pin is fixed axially to the yoke.

16. The tool of claim 15 including an alignment pin extending axially from the anvil and axially slidable in the yoke.
